(19) United States
(12) Patent Application Publication
(10) Pub. No.: US 2024/0081409 A1
(43) Pub. Date: Mar. 14, 2024

(54) AEROSOL GENERATION SYSTEM

(71) Applicant: JAPAN TOBACCO INC., Tokyo (JP)

(72) Inventors: Manabu YAMADA, Tokyo (JP); Yasunobu INOUE, Tokyo (JP)

(73) Assignee: JAPAN TOBACCO INC., Tokyo (JP)

(21) Appl. No.: 18/518,874

(22) Filed: Nov. 24, 2023

Related U.S. Application Data
(63) Continuation of application No. PCT/JP2021/024409, filed on Jun. 28, 2021.

(51) Int. Cl. A24F 40/46; H05B 3/03; H05B 3/20

(52) U.S. Cl. CPC A24F 40/46; H05B 3/03; H05B 3/20

(57) ABSTRACT

This aerosol generation system including a heating unit for heating an aerosol generation component, and an electric power supply unit for supplying electric power to the heating unit. The heating unit has a ceramic part, an electricity-resistant part that is disposed inside the ceramic part and that generates heat due to the electric power supplied from the electric power supply unit, and a metal electrode that is disposed in close contact with the vicinity of the ceramic part and that electrically connects the electricity-resistant part and the electric power supply unit. The heating unit is inserted into the aerosol generation component.

### CROSS REFERENCES TO RELATED APPLICATIONS

This application is a continuation application based on International Patent Application No. PCT/JP2021/024409 filed on Jun. 28, 2021, and the content of the PCT international application is incorporated herein by reference.

### TECHNICAL FIELD

The present invention relates to aerosol generation systems.

### BACKGROUND ART

Inhaler devices including electronic cigarettes and nebulizers that generate material to be inhaled by users are becoming widely popular. For example, an inhaler device uses a substrate, which contains an aerosol source for generating an aerosol and a flavor source for imparting a flavor component to the generated aerosol, so as to generate a flavor-component-imparted aerosol. A user can taste the flavor by inhaling the flavor-component-imparted aerosol generated by the inhaler device. The act of the user inhaling the aerosol may also be referred to as “puff” or “puff action” hereinafter.

In recent years, inhaler devices of a type that uses stick-shaped substrates are becoming widely popular, and technologies related to inhaler devices of this type are being actively developed. For example, Patent Literature 1 indicated below discloses a technology in which, when the stick-shaped substrate is inserted into the inhaler device, a blade-shaped heater is inserted into the substrate to heat the substrate from the inside thereof.

### CITATION LIST

### Patent Literature

Patent Literature 1: JP 5854394 B2

### SUMMARY OF INVENTION

### Technical Problem

However, the inhaler device that uses the blade-shaped heater is problematic in that the heater breaks easily.

The present invention has been made in view of the above problem, and an object of the present invention is to provide a mechanism that can prevent the heater from breaking.

### Solution to Problem

In order to solve the above problem, an aspect of the present invention provides an aerosol generation system including: a heater that heats an aerosol generation article; and a power supply unit that supplies electric power to the heater. The heater is inserted into the aerosol generation article and includes a ceramic unit, an electric resistor that is disposed inside the ceramic unit and produces heat in accordance with the electric power supplied from the power supply unit, and a metallic electrode that is disposed in close contact with a periphery of the ceramic unit and electrically connects the electric resistor and the power supply unit to each other.

The electrode may extend in a direction in which the heater is inserted into the aerosol generation article, and may cover a side surface of the ceramic unit.

The electrode may have two or more surfaces that cover two or more side surfaces of the ceramic unit.

An area of the ceramic unit that is in contact with the electrode may have a rectangular cross-sectional shape, and an angle formed between adjacent surfaces of the two or more surfaces that the electrode has may be a right angle.

The electrode included in the heater may include two electrodes that are apart from each other.

The two electrodes may be disposed with the ceramic unit interposed therebetween in a direction orthogonal to a direction in which the heater is inserted into the aerosol generation article.

The electrode may be longer than the ceramic unit in a direction in which the heater is inserted into the aerosol generation article.

The ceramic unit and the electrode may be bonded together by using a conductive adhesive.

The heater may be inserted into the aerosol generation article from a leading end of the heater, and the leading end of the heater may be sharp.

A leading end of the ceramic unit may be sharp and may be exposed from the electrode.

The heater may have a plurality of areas that produce heat at different temperatures in a direction in which the heater is inserted into the aerosol generation article.

The electric resistor may be distributed non-uniformly in the direction in which the heater is inserted into the aerosol generation article.

The aerosol generation system may further include: a container that has an internal space and an opening through which the internal space communicates with an outside, and that accommodates the aerosol generation article inserted into the internal space through the opening; and a holder that holds the heater such that a leading end of the heater protrudes in a direction extending from a bottom of the container toward the opening.

The holder may hold the electrode.

The ceramic unit may be electrically insulative.

The electric resistor may be composed of SUS.

The electric resistor may be a conductive track.

The aerosol generation system may include the aerosol generation article.

### Advantageous Effects of Invention

According to the present invention described above, a mechanism that can prevent the heater from breaking is provided.

### BRIEF DESCRIPTION OF DRAWINGS

FIG. 1 is a schematic diagram schematically illustrating a configuration example of an inhaler device.

FIG. 2 is a perspective view of a heater according to an embodiment.

FIG. 3 is an exploded perspective view of the heater according to this embodiment.

FIG. 4 is a top view of the heater according to this embodiment.

FIG. 5 is a cross-sectional view of a part where the heater is disposed in the inhaler device according to this embodiment.

### DESCRIPTION OF EMBODIMENTS

A preferred embodiment of the present invention will be described in detail below with reference to the appended drawings. In this description and the drawings, structural elements having substantially identical functional configurations will be given the same reference signs, and redundant descriptions thereof will be omitted.

1. Configuration Example of Inhaler Device

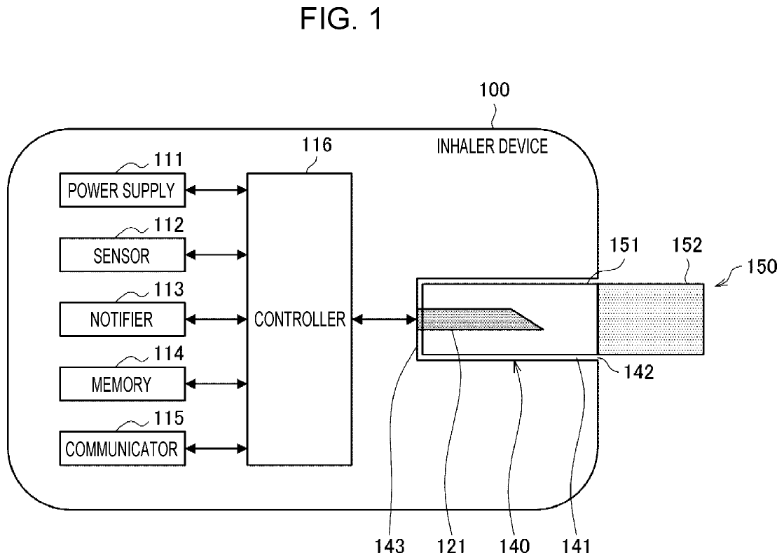

An inhaler device according to this configuration example generates an aerosol by heating a substrate containing an aerosol source from inside the substrate. A present configuration example will be described below with reference to FIG. 1.

FIG. 1 is a schematic diagram schematically illustrating a configuration example of the inhaler device. As illustrated in FIG. 1, an inhaler device 100 according to this configuration example includes a power supply 111, a sensor 112, a notifier 113, a memory 114, a communicator 115, a controller 116, a heater 121, and a container 140. Inhalation is performed by a user in a state where a stick substrate 150 is accommodated in the container 140. Each structural element will be sequentially described below.

The power supply 111 stores electric power. The power supply 111 supplies the electric power to the structural elements of the inhaler device 100. For example, the power supply 111 may be a rechargeable battery, such as a lithium ion secondary battery. The power supply 111 may be recharged by being connected to an external power supply by, for example, a USB (universal serial bus) cable. Alternatively, the power supply 111 may be recharged in a non-connected state with a power-transmitting device by wireless power transmission technology. As another alternative, the power supply 111 alone may be removable from the inhaler device 100 so as to be replaceable with a new power supply 111.

The sensor 112 detects various types of information regarding the inhaler device 100. The sensor 112 then outputs the detected information to the controller 116. In an example, the sensor 112 may be a pressure sensor such as a microphone condenser, a flow sensor, or a temperature sensor. When detecting a numerical value generated in accordance with the user's inhalation, the sensor 112 outputs information indicating that the inhalation has been performed by the user to the controller 116. In another example, the sensor 112 is an input device, such as a button or a switch, receiving information input by the user. In particular, the sensor 112 may include a command button for starting/stopping aerosol generation. The sensor 112 then outputs the information input by the user to the controller 116. In another example, the sensor 112 is a temperature sensor that detects the temperature of the heater 121. For example, the temperature sensor detects the temperature of the heater 121 based on an electrical resistance value of a conductive track of the heater 121. The sensor 112 may detect the temperature of the stick substrate 150 accommodated in the container 140 based on the temperature of the heater 121.

The notifier 113 notifies the user of information. In an example, the notifier 113 is a light-emitting device, such as an LED (light-emitting diode). In that case, for example, when the power supply 111 needs to be recharged, when the power supply 111 is being recharged, and when an abnormality has occurred in the inhaler device 100, the notifier 113 emits light in different patterns of light, respectively. Each pattern of light is a concept involving colors and on/off timings. Together with or in place of the light-emitting device, the notifier 113 may be, for example, a display device that displays an image, a sound output device that outputs sound, and a vibration device that vibrates. The notifier 113 may also provide notification information indicating that inhalation by the user is possible. The notification information indicating that inhalation by the user is possible is provided when the temperature of the stick substrate 150 heated by the heater 121 reaches a predetermined temperature.

The memory 114 stores various types of information for operation of the inhaler device 100. The memory 114 is, for example, a non-volatile storage medium, such as a flash memory. An example of the information stored in the memory 114 is information regarding the OS (operating system) of the inhaler device 100, such as the control contents of the various types of structural elements controlled by the controller 116. Another example of the information stored in the memory 114 is information regarding inhalation by the user, such as the number of times of inhalation, the inhalation time, and the accumulated inhalation time period.

The communicator 115 is a communication interface for exchanging information between the inhaler device 100 and another device. The communicator 115 performs communication in conformity with any wired or wireless communication standard. Such a communication standard may be, for example, a wireless LAN (local area network), a wired LAN, Wi-Fi (registered trademark), or Bluetooth (registered trademark). In an example, the communicator 115 transmits the information regarding the inhalation by the user to a smartphone to cause the smartphone to display the information regarding the inhalation by the user. In another example, the communicator 115 receives information about a new OS from a server to update the information about the OS stored in the memory 114.

The controller 116 functions as an arithmetic processing unit and a control device, and controls the overall operation in the inhaler device 100 in accordance with various programs. For example, the controller 116 is implemented by an electronic circuit, such as a CPU (central processing unit) and a microprocessor. Furthermore, the controller 116 may include a ROM (read only memory) that stores a program and arithmetic parameter to be used, and a RAM (random access memory) that temporarily stores an appropriately changing parameter. The inhaler device 100 executes various processes based on control by the controller 116. Examples of the processes controlled by the controller 116 include supplying of electric power from the power supply 111 to the other structural elements, recharging of the power supply 111, detection of information by the sensor 112, notification of information by the notifier 113, storing and reading of information by the memory 114, and exchanging of information by the communicator 115. Other processes executed by the inhaler device 100, such as input of information to each structural element and a process based on information output from each structural element, are also controlled by the controller 116.

The container 140 has an internal space 141 and holds the stick substrate 150 while accommodating a portion of the stick substrate 150 within the internal space 141. The container 140 has an opening 142 through which the internal space 141 communicates with the outside, and holds the stick substrate 150 inserted in the internal space 141 through the opening 142. For example, the container 140 is a tubular body having the opening 142 and a bottom 143 as a bottom surface, and defines the internal space 141 that is pillar-shaped. The container 140 has an inside diameter smaller than an outside diameter of the stick substrate 150 in at least a portion of the tubular body in the height direction, and may hold the stick substrate 150 while applying pressure around the stick substrate 150 inserted in the internal space 141. The container 140 also has a function for defining a flow path for air traveling through the stick substrate 150. An air inlet serving as an inlet for the air entering the flow path is disposed in, for example, the bottom 143. On the other hand, an air outlet serving as an outlet for the air exiting from the flow path is the opening 142.

The stick substrate 150 is a stick-shaped member. The stick substrate 150 includes a substrate 151 and an inhalation port 152.

The substrate 151 contains an aerosol source. The aerosol source atomizes by being heated, so that an aerosol is generated. The aerosol source may be, for example, a product derived from tobacco, such as a product obtained by forming shredded tobacco or tobacco raw material into a granular form, a sheet form, or a powder form. The aerosol source may include a product not derived from tobacco and made from a plant (such as mint or herb) other than tobacco. In an example, the aerosol source may contain a flavor component, such as menthol. If the inhaler device 100 is a medical inhaler, the aerosol source may contain a medicine to be inhaled by a patient. The aerosol source is not limited to a solid and may be a liquid, such as polyhydric alcohol including glycerine and propylene glycol, or water. At least a portion of the substrate 151 is accommodated in the internal space 141 of the container 140 in the state where the stick substrate 150 is held by the container 140.

The inhalation port 152 is a member to be held in the user's mouth during inhalation. At least a portion of the inhalation port 152 protrudes from the opening 142 in the state where the stick substrate 150 is held by the container 140. When the user holds the inhalation port 152 protruding from the opening 142 in the user's mouth and inhales, air flows into the container 140 through the air inlet (not illustrated). The air flowing in travels through the internal space 141 of the container 140, that is, through the substrate 151, and reaches the inside of the user's mouth together with the aerosol generated from the substrate 151.

The heater 121 heats the aerosol source so as to atomize the aerosol source and generate the aerosol. The heater 121 is composed of any material, such as metal or polyimide. For example, the heater 121 has a sharp leading end and is disposed to protrude from the bottom 143 of the container 140 to the internal space 141 of the container 140. Therefore, when the stick substrate 150 is inserted into the container 140, the heater 121 is inserted into the stick substrate 150 to pierce the substrate 151 of the stick substrate 150. When the heater 121 produces heat, the aerosol source contained in the stick substrate 150 atomizes by being heated from inside the stick substrate 150, whereby the aerosol is generated. The heater 121 produces heat when supplied with electric power from the power supply 111. In an example, when the sensor 112 detects that a predetermined user input has been performed, electric power may be supplied so that the aerosol is generated. When the temperature of the stick substrate 150 heated by the heater 121 reaches the predetermined temperature, inhalation by the user becomes possible. Subsequently, when the sensor 112 detects that a predetermined user input has been performed, the supply of electric power may be stopped. In another example, in a time period in which the sensor 112 detects that the inhalation has been performed by the user, electric power may be supplied so that the aerosol is generated.

The power supply 111 is an example of a power supply unit that supplies electric power to the heater 121. The stick substrate 150 is an example of an aerosol generation article containing the aerosol source.

The inhaler device 100 and the stick substrate 150 work in cooperation with each other to generate the aerosol to be inhaled by the user. Therefore, the combination of the inhaler device 100 and the stick substrate 150 may be regarded as an aerosol generation system.

2. Detailed Configuration of Heater

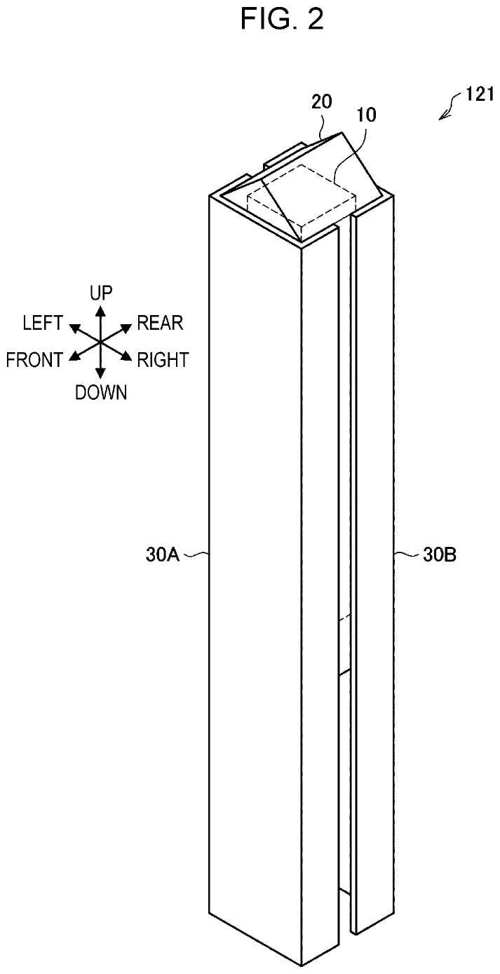

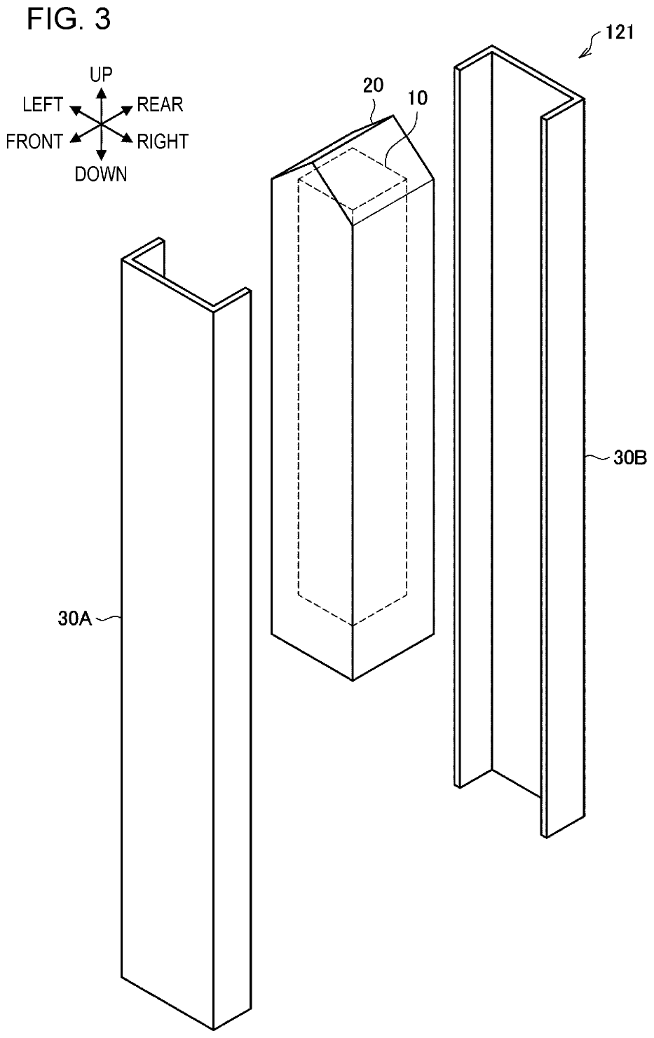

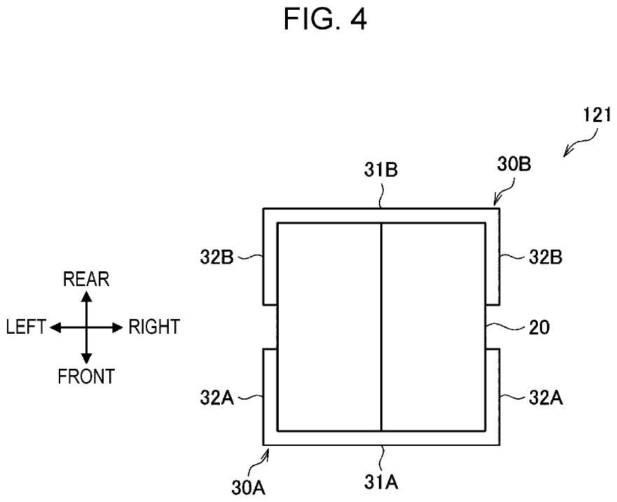

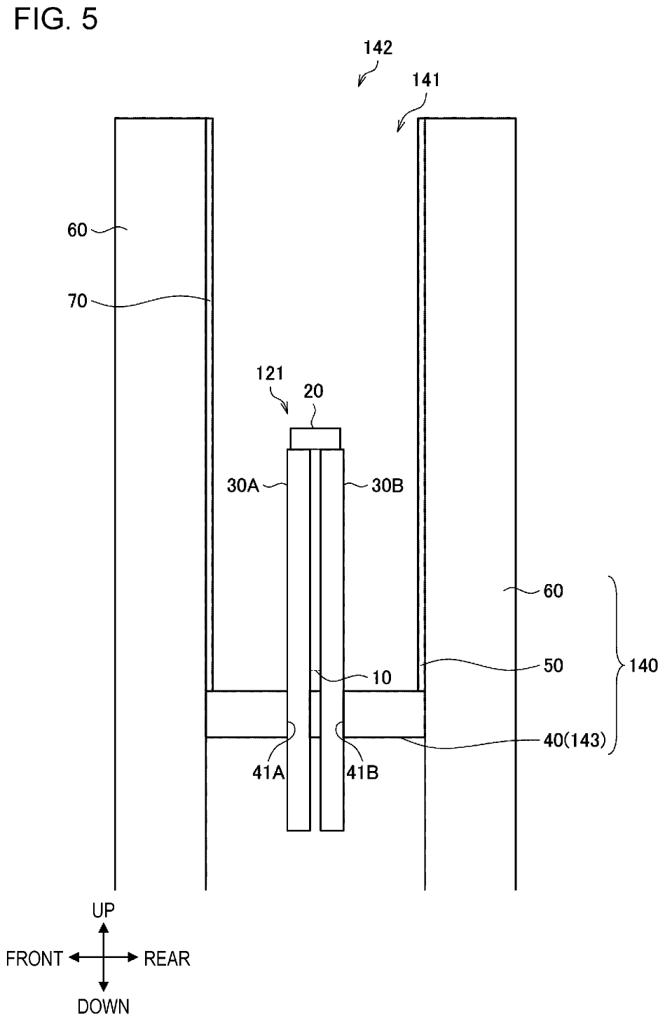

FIG. 2 is a perspective view of the heater 121 according to this embodiment. FIG. 3 is an exploded perspective view of the heater 121 according to this embodiment. FIG. 4 is a top view of the heater 121 according to this embodiment. FIG. 5 is a cross-sectional view of a part where the heater 121 is disposed in the inhaler device 100 according to this embodiment.

As illustrated in FIG. 2 to FIG. 4, the heater 121 has an electric resistor 10, a ceramic unit 20, and electrodes 30 (30A and 30B). As illustrated in FIG. 5, the heater 121 is disposed to protrude into the internal space 141 of the container 140.

In this description and the drawings, elements having substantially identical functional configurations may sometimes be differentiated from each other by adding a different alphabet to the suffix of the same reference sign. For example, a plurality of elements having substantially identical functional configurations are differentiated from each other as in an electrode 30A and an electrode 30B, where necessary. However, if it is not necessary to particularly differentiate a plurality of elements having substantially identical functional configurations from each other, the same reference sign is given. For example, if the electrodes 30A and 30B do not particularly need to be differentiated from each other, they will simply be referred to as “electrodes 30”.

In these drawings, a direction in which the stick substrate 150 is inserted toward the heater 121 may also be referred to as “down direction”. A direction in which the stick substrate 150 is removed from the heater 121 may also be referred to as “up direction”. With regard to the heater 121, an end in the up direction may also be referred to as “leading end”, whereas an end in the down direction may also be referred to as “trailing end”. The up-down direction corresponds to the longitudinal direction of the heater 121.

A direction in which the electric resistor 10, the ceramic unit 20, and the electrodes 30 overlap one another may also be referred to as “front-rear direction”. The lateral direction of the electrodes 30 may also be referred to as “left-right direction”. The up-down direction, the front-rear direction, and the left-right direction are orthogonal to one another.

The structural elements related to the heater 121 will be described in detail below.

The ceramic unit 20 is a member composed of a ceramic material, that is, a non-metallic inorganic material. In an example, the ceramic unit 20 is composed of a fine ceramic material. Thus, the ceramic unit 20 can exhibit high strength and heat resisting properties. Furthermore, the ceramic unit 20 is insulative. Thus, a short-circuit can be prevented from occurring in a circuit constituted by the electric resistor 10 and the electrodes 30.

The electric resistor 10 is disposed inside the ceramic unit 20. The electric resistor 10 produces heat in accordance with electric power supplied from the power supply 111. Specifically, the electric resistor 10 produces Joule heat when electric current flows therethrough. The electric resistor 10 is composed of, for example, SUS (steel use stainless). In that case, the electric resistor 10 can exhibit high heat resisting properties.

For example, the electric resistor 10 may be a conductive track. The conductive track is routed while being bent within the ceramic unit 20. Heat distribution in the heater 121 can be designed arbitrarily in accordance with the distribution (i.e., density) of the conductive track within the ceramic unit 20.

The electrodes 30 are disposed in close contact with the periphery of the ceramic unit 20. The electrodes 30 electrically connect the electric resistor 10 and the power supply 111 to each other. For example, the electrode 30A and the electrode 30B are electrically connected to each other by the electric resistor 10, and are connected to the power supply 111 by a conductive wire. Accordingly, electric power supplied from the power supply 111 is supplied to the electric resistor 10 via the electrodes 30, so that the electric resistor 10 can produce heat.

The electrodes 30 are metallic members. The electrodes 30 have predetermined rigidity. With this configuration, the electrodes 30 exhibit rigidity against a force applied to the heater 121, so as to prevent the heater 121 from buckling. Furthermore, the electrodes 30 have predetermined heat transmissibility. Therefore, the electrodes 30 increase in temperature in accordance with the heat transmitted from the electric resistor 10, and are capable of transmitting the heat produced by the electric resistor 10 to the stick substrate 150. In an example, the electrodes 30 are composed of SUS.

As illustrated in FIG. 2 to FIG. 4, the electrodes 30 extend in the up-down direction and cover the side surfaces of the ceramic unit 20. With this configuration, the electrodes 30 can attenuate a force applied laterally to the ceramic unit 20. Therefore, the heater 121 can be prevented from buckling.

As illustrated in FIG. 2 to FIG. 4, each electrode 30 has three surfaces covering three side surfaces of the ceramic unit 20. Specifically, the electrode 30A has a first surface 31A extending in the left-right direction and two second surfaces 32A extending rearward from the left and right edges of the first surface 31A. Likewise, the electrode 30B has a first surface 31B extending in the left-right direction and two second surfaces 32B extending forward from the left and right edges of the first surface 31B. With this configuration, a larger number of side surfaces of the ceramic unit 20 are covered by the electrodes 30, so that the heater 121 can be further prevented from buckling.

As illustrated in FIG. 4, an area of the ceramic unit 20 in contact with the electrodes 30 has a rectangular cross-sectional shape. An angle formed between adjacent surfaces of two or more surfaces that each electrode 30 has is a right angle. Specifically, an angle formed by the first surface 31 and the two second surfaces 32 is a right angle. Accordingly, the second surfaces 32 function as ribs for the first surface 31, so that the rigidity of each electrode 30 can be enhanced. Therefore, the heater 121 can be further prevented from buckling.

As illustrated in FIG. 2 to FIG. 4, the electrode 30A and the electrode 30B are disposed with the ceramic unit 20 interposed therebetween in the front-rear direction. Specifically, the electrode 30A covers the front side surface of the ceramic unit 20, and the electrode 30B covers the rear side surface of the ceramic unit 20. With this configuration, the electrode 30A and the electrode 30B can both attenuate a force applied laterally to the ceramic unit 20. Therefore, the heater 121 can be further prevented from buckling.

As illustrated in FIG. 4, the electrode 30A and the electrode 30B are disposed apart from each other. Specifically, the electrode 30A and the electrode 30B are disposed apart from each other in the front-rear direction. With this configuration, a short-circuit can be prevented.

The ceramic unit 20 and the electrodes 30 are bonded together by using a conductive adhesive. An example of the conductive adhesive is epoxy resin mixed with conductive metal particles. In that case, a heat curing process is performed in a state where the conductive adhesive is applied to the bonding surfaces between the ceramic unit 20 and the electrodes 30, whereby the ceramic unit 20 and the electrodes 30 are adhered to each other. This configuration strengthens the bond between the ceramic unit 20 and the electrodes 30, and can facilitate the electrical connection between the electrodes 30 and the electric resistor 10.

As illustrated in FIG. 2 and FIG. 5, the electrodes 30 are longer than the ceramic unit 20 in the up-down direction. Specifically, the electrodes 30 extend downward further than the lower end of the ceramic unit 20. With this configuration, a holder 40, to be described later, can hold the heater 121 by holding an area of each electrode 30 extending downward further than the lower end of the ceramic unit 20.

The heater 121 is inserted into the stick substrate 150 from the leading end of the heater 121. The leading end of the heater 121 is sharp. In this embodiment, as illustrated in FIG. 2 and FIG. 3, the leading end of the ceramic unit 20 is sharp and is exposed from the electrodes 30. Specifically, an area of the ceramic unit 20 surrounded by the electrodes 30 has a quadrangular prismatic shape, and the leading end exposed from the electrodes 30 decreases in cross-sectional area in the up direction. Accordingly, the heater 121 entirely has a needle-like shape. With this configuration, when the heater 121 is inserted into the stick substrate 150, the resistance that the heater 121 receives from the stick substrate 150 can be attenuated. Therefore, the heater 121 can be further prevented from buckling.

The heater 121 may have a plurality of areas that produce heat at different temperatures in the up-down direction. In an example, the heater 121 may have a high heating area that produces heat at high temperature and a low heating area that produces heat at low temperature. With this configuration, the stick substrate 150 can be heated with an optimal temperature distribution.

The electric resistor 10 may be distributed non-uniformly in the up-down direction. In an example, the electric resistor 10 may be distributed at different densities between the high heating area and the low heating area. With this configuration, the heater 121 can produce heat at different temperatures in the up-down direction.

As illustrated in FIG. 5, the container 140 has a holder 40, an interior member 50, and an exterior member 60. The exterior member 60 is a tubular member. The exterior member 60 may serve as an outermost shell of the inhaler device 100. The interior member 50 serves as an inner wall (i.e., a sidewall) of the container 140. On the other hand, the holder 40 serves as the bottom 143 of the container 140.

The holder 40 is a member that holds the heater 121. As illustrated in FIG. 5, the holder 40 holds the heater 121 such that the leading end of the heater 121 protrudes in a direction extending from the bottom 143 of the container 140 toward the opening 142. With this configuration, when the stick substrate 150 is inserted into the internal space 141 through the opening 142, the leading end of the heater 121 pierces the stick substrate 150, so that the heater 121 can be inserted into the stick substrate 150.

The holder 40 is composed of a material having high heat resisting properties. For example, the holder 40 is composed of PEEK (polyether ether ketone). With this configuration, the heater 121 can be continuously held even when the heater 121 produces high heat.

As illustrated in FIG. 5, the holder 40 holds the electrodes 30. Specifically, the holder 40 is a tabular member having two through-holes 41 (41A and 41B) extending therethrough in the up-down direction. In a state where the trailing ends of the electrode 30A and the electrode 30B extend through the through-holes 41 and the lower end of the ceramic unit 20 is in contact with the upper surface of the holder 40, the electrodes 30 and the holder 40 are joined together. With this configuration, the holder 40 holds the electrodes 30 having predetermined rigidity, so as to be capable of holding the heater 121 securely. Moreover, since the holding force is prevented from being applied to the ceramic unit 20, the ceramic unit 20 can be prevented from breaking.

3. Supplemental Remarks

Although a preferred embodiment of the present invention has been described in detail above with reference to the appended drawings, the present invention is not limited to this example. It is apparent to a person with a common knowledge of the technical field to which the present invention belongs that various modifications and alterations are conceivable within the scope of the technical ideas defined in the claims, and it is to be understood that such modifications and alterations naturally belong to the technical scope of the present invention.

For example, although the above embodiment relates to an example where each electrode 30 has three surfaces that cover three side surfaces of the ceramic unit 20, the present invention is not limited to this example. In an example, each electrode 30 may have two or fewer surfaces that cover two or fewer side surfaces of the ceramic unit 20. In another example, the ceramic unit 20 may have a polygonal cross-sectional shape. In that case, each electrode 30 may have four or more surfaces that cover four or more side surfaces of the ceramic unit 20. In another example, the ceramic unit 20 may have a circular cross-sectional shape. In that case, each electrode 30 may have a circular-arc-like cross-sectional shape.

For example, although the above embodiment relates to an example where the electrode 30A and the electrode 30B have the same shape, the present invention is not limited to this example. The electrode 30A and the electrode 30B may have different shapes. For example, the electrode 30A may have the first surface 31A extending in the left-right direction and the two second surfaces 32A extending rearward from the left and right edges of the first surface 31A, whereas the electrode 30B may have the first surface 31B alone extending in the left-right direction.

For example, although the above embodiment relates to an example where the heater 121 has two electrodes 30, the present invention is not limited to this example. The heater 121 may have one electrode 30. In that case, for example, a connection point that electrically connects the electric resistor 10 and the power supply 111 to each other at the lower end of the ceramic unit 20 may be additionally provided.

For example, although the above embodiment relates to an example where the leading end of the ceramic unit 20 is exposed from the electrodes 30, the present invention is not limited to this example. The leading end of the ceramic unit 20 may at least partially be covered by the electrodes 30.

For example, although the above embodiment relates to an example where the ceramic unit 20 and the electrodes 30 are bonded together by using a conductive adhesive, the present invention is not limited to this example. In another example, the ceramic unit 20 and the electrodes 30 may be soldered together.

The following configurations also belong to the technical scope of the present invention.

(1) An aerosol generation system comprising:
a heater that heats an aerosol generation article; and
a power supply unit that supplies electric power to the heater,
wherein the heater is inserted into the aerosol generation article and includes
   a ceramic unit,
   an electric resistor that is disposed inside the ceramic unit and produces heat in accordance with the electric power supplied from the power supply unit, and
   a metallic electrode that is disposed in close contact with a periphery of the ceramic unit and electrically connects the electric resistor and the power supply unit to each other.

(2) The aerosol generation system according to (1),
wherein the electrode extends in a direction in which the heater is inserted into the aerosol generation article, and covers a side surface of the ceramic unit.

(3) The aerosol generation system according to (2),
wherein the electrode has two or more surfaces that cover two or more side surfaces of the ceramic unit.

(4) The aerosol generation system according to (3),
wherein an area of the ceramic unit that is in contact with the electrode has a rectangular cross-sectional shape, and an angle formed between adjacent surfaces of the two or more surfaces that the electrode has is a right angle.

(5) The aerosol generation system according to any one of (1) to (4),
wherein the electrode included in the heater comprises two electrodes that are apart from each other.

(6) The aerosol generation system according to (5),
wherein the two electrodes are disposed with the ceramic unit interposed therebetween in a direction orthogonal to a direction in which the heater is inserted into the aerosol generation article.

(7) The aerosol generation system according to any one of (1) to (6),
wherein the electrode is longer than the ceramic unit in a direction in which the heater is inserted into the aerosol generation article.

(8) The aerosol generation system according to any one of (1) to (7),
wherein the ceramic unit and the electrode are bonded together by using a conductive adhesive.

(9) The aerosol generation system according to any one of (1) to (8),
wherein the heater is inserted into the aerosol generation article from a leading end of the heater, and
wherein the leading end of the heater is sharp.

(10) The aerosol generation system according to (9),
wherein a leading end of the ceramic unit is sharp and is exposed from the electrode.

(11) The aerosol generation system according to any one of (1) to (10),
wherein the heater has a plurality of areas that produce heat at different temperatures in a direction in which the heater is inserted into the aerosol generation article.

(12) The aerosol generation system according to (11),
wherein the electric resistor is distributed non-uniformly in the direction in which the heater is inserted into the aerosol generation article.

(13) The aerosol generation system according to any one of (1) to (12),
wherein the aerosol generation system further comprises:
a container that has an internal space and an opening through which the internal space communicates with an outside, and that accommodates the aerosol generation article inserted into the internal space through the opening; and
a holder that holds the heater such that a leading end of the heater protrudes in a direction extending from a bottom of the container toward the opening.

(14) The aerosol generation system according to (13),
wherein the holder holds the electrode.

(15) The aerosol generation system according to any one of (1) to (14),
wherein the ceramic unit is electrically insulative.

(16) The aerosol generation system according to any one of (1) to (15),
wherein the electric resistor is composed of SUS.

(17) The aerosol generation system according to any one of (1) to (16),
wherein the electric resistor is a conductive track.

(18) The aerosol generation system according to any one of (1) to (17),
wherein the aerosol generation system includes the aerosol generation article.

### REFERENCE SIGNS LIST

100 inhaler device
111 power supply
112 sensor
113 notifier
114 memory
115 communicator
116 controller
121 heater
140 container
141 internal space
142 opening
143 bottom
150 stick substrate
151 substrate
152 inhalation port
10 electric resistor
20 ceramic unit
30 electrode
31 first surface
32 second surface
40 holder
41 through-hole
50 interior member
60 exterior member

1. An aerosol generation system comprising:
a heater that heats an aerosol generation article; and
a power supply unit that supplies electric power to the heater,
wherein the heater is inserted into the aerosol generation article and includes
a ceramic unit,
an electric resistor that is disposed inside the ceramic unit and produces heat in accordance with the electric power supplied from the power supply unit, and
a metallic electrode that is disposed in close contact with a periphery of the ceramic unit and electrically connects the electric resistor and the power supply unit to each other.

2. The aerosol generation system according to claim 1,
wherein the electrode extends in a direction in which the heater is inserted into the aerosol generation article, and covers a side surface of the ceramic unit.

3. The aerosol generation system according to claim 2,
wherein the electrode has two or more surfaces that cover two or more side surfaces of the ceramic unit.

4. The aerosol generation system according to claim 3,
wherein an area of the ceramic unit that is in contact with the electrode has a rectangular cross-sectional shape, and an angle formed between adjacent surfaces of the two or more surfaces that the electrode has is a right angle.

5. The aerosol generation system according to claim 1,
wherein the electrode included in the heater comprises two electrodes that are apart from each other.

6. The aerosol generation system according to claim 5,
wherein the two electrodes are disposed with the ceramic unit interposed therebetween in a direction orthogonal to a direction in which the heater is inserted into the aerosol generation article.

7. The aerosol generation system according to claim 1,
wherein the electrode is longer than the ceramic unit in a direction in which the heater is inserted into the aerosol generation article.

8. The aerosol generation system according to claim 1,
wherein the ceramic unit and the electrode are bonded together by using a conductive adhesive.

9. The aerosol generation system according to claim 1,
wherein the heater is inserted into the aerosol generation article from a leading end of the heater, and
wherein the leading end of the heater is sharp.

10. The aerosol generation system according to claim 9,
wherein a leading end of the ceramic unit is sharp and is exposed from the electrode.

11. The aerosol generation system according to claim 1,
wherein the heater has a plurality of areas that produce heat at different temperatures in a direction in which the heater is inserted into the aerosol generation article.

12. The aerosol generation system according to claim 11,
wherein the electric resistor is distributed non-uniformly in the direction in which the heater is inserted into the aerosol generation article.

13. The aerosol generation system according to claim 1,
wherein the aerosol generation system further comprises:
a container that has an internal space and an opening through which the internal space communicates with an outside, and that accommodates the aerosol generation article inserted into the internal space through the opening; and
a holder that holds the heater such that a leading end of the heater protrudes in a direction extending from a bottom of the container toward the opening.

14. The aerosol generation system according to claim 13,
wherein the holder holds the electrode.

15. The aerosol generation system according to claim 1,
wherein the ceramic unit is electrically insulative.

16. The aerosol generation system according to claim 1,
wherein the electric resistor is composed of SUS.

17. The aerosol generation system according to claim 1,
wherein the electric resistor is a conductive track.

18. The aerosol generation system according to claim 1,
wherein the aerosol generation system includes the aerosol generation article.
